(19) United States
(12) Patent Application Publication
(10) Pub. No.: US 2016/0185633 A1
(43) Pub. Date: Jun. 30, 2016

(54) RECOVERY OF NUTRIENTS FROM WATER AND WASTEWATER BY PRECIPITATION AS STRUVITE

(71) Applicant: University of Florida Research Foundation, Inc., Gainesville, FL (US)

(72) Inventors: Pratap Pullammanappallil, Gainesville, FL (US); Gayathri Ram Mohan, Marietta, GA (US)

(21) Appl. No.: 14/983,925

(22) Filed: Dec. 30, 2015

Related U.S. Application Data
(60) Provisional application No. 62/097,838, filed on Dec. 30, 2014.

(51) Int. Cl. C02F 3/12; C05B 7/00

(52) U.S. Cl. CPC C02F 3/1263; C05B 7/00; C02F 2101/105

(57) ABSTRACT

The present invention generally relates to a process for converting waste to nutrients. Preferably, the subject invention relates to systems and methods for recovering nutrients from wastewaters. More preferably, the subject invention relates to systems and methods for processing anaerobically treated cellulosic stillage generated from ethanol production to recover struvite precipitate. According to the present invention, a sequential batch reactor is provided for recovery of nutrients via struvite precipitation from cellulosic ethanol stillage seeded with stillage fibrous biomass. The effect of seeding using stillage biomass as seeding decreases time for struvite precipitation and settling within the reactor.

### CROSS-REFERENCE TO A RELATED APPLICATION

This application claims the benefit of U.S. Provisional Application Ser. No. 62/097,838, filed Dec. 30, 2014, which is incorporated herein by reference in its entirety.

### BACKGROUND OF THE INVENTION

Removal of nitrogen (N) and phosphorous (P) from wastewaters is becoming an increasing challenge for operators as regulatory authorities tighten discharge standards to avoid eutrophication problems in receiving waters. Currently a number of physical, chemical and biological techniques have been employed to treat high levels of N and P in wastewaters prior to their disposal to water bodies. This is an important step in wastewater treatment as direct discharge of wastewaters rich in nutrients is illegal in many countries and such actions have deleterious effect on aquatic life.

Mineral phosphates are a non-renewable resource that is being mined at an increasing rate to meet the increasing demand of various industries including; fertilizer, detergent and insecticide industries. While there is shortage of naturally available mineral phosphates, phosphates present in waste side streams such as agricultural run offs and industrial effluents disposed of into water bodies or land applied are posing a threat to the environment. Thus, it is wise to recover and reuse phosphate from wastewaters in order to reduce dependence on mineral phosphate resources as well as avoid any negative impact on the environment.

Since the 1950s, various technologies have been proposed for removal of phosphorus from wastewater in response to the issue of eutrophication. Examples of phosphate removal techniques presently used in large scale industries include: physical removal using filtration or membrane technologies; chemical removal using precipitation or adsorption techniques; and biological removal using assimilation or enhanced biological phosphorous removal.

Filtration is a conventional physical treatment for removal of particulate phosphate using sand filters or other media that help trap sediments and particulate matters. However, conventional filtration techniques fail to completely remove suspended matter, thus allowing high levels of residual phosphorous in wastewater effluents. Use of technologies such as membrane bioreactors, provides a way of introducing a physical barrier that is capable of capturing the suspended solids from treated wastewaters. Studies employing submerged membrane bioreactors for nutrient removal have shown that when used in combination with chemical or biological phosphorous removal techniques, membrane technology can help remove up to 70% and 93% of N and P, respectively, from treated wastewaters.

In chemical precipitation, metal salts such as alum, ferric chloride or calcium are added to precipitate out phosphorous present in wastewaters. Application of such chemical precipitation techniques suffer from limitations such as additional costs associated with use of chemicals and need for post sludge processing. Therefore, such techniques are used for secondary or tertiary treatment post initial biological treatment of wastewaters.

Various adsorbents such as granulated ferric hydroxide, activated aluminum oxide, biochar and activated carbon have also been used for phosphorous removal from biologically treated wastewaters. Such methods are useful as polishing agents that reduce the final nutrient level to meet the regulatory standards post biological or chemical nutrient removal. However, use of such treatment technologies as primary means of nutrient removal may not be economical.

Biological phosphate removal technology involves the use of phosphate accumulating organism's (PAO's) that are grown in alternating anaerobic/aerobic conditions. These organisms release phosphate during the anaerobic phase when volatile fatty acids are produced. VFA's are then broken down by these organisms during the aerobic phase when phosphate uptake occurs. Such a process helps reduce higher phosphate levels in treated wastewaters by increasing the P uptake capability of microorganisms from 1.5% to 5%.

Although physical and biological techniques mentioned above possess a number of advantages, one common disadvantage these methods suffer from is their focus on phosphate removal rather than recovery in a reusable form.

Struvite precipitation is a means of recovering nutrients, mainly phosphorous and nitrogen from treated wastewaters. The key feature of this nutrient recovery technique is the combined removal of ammonium (NH₄⁺), phosphate (PO₄³⁻) and magnesium (Mg²⁺) from supersaturated stillage in the form of magnesium-ammonium-phosphate hexahydrate (MgNH₄PO₄.6H2O), commonly known as struvite. Struvite usually precipitates as stable, white, orthorhombic crystals in the stoichiometric ratio Mg²⁺:NH₄⁺—N:PO₄³⁻—P=1:1:1 according to following reaction:

Mg²⁺+NH₄⁺+PO₄³⁻+6H₂O→MgNH₄PO₄.6H₂O↓ (1)

The recovery of NH₄⁺ or PO₄³⁻ as struvite from various types of wastewaters have been proposed, including from landfill leachate, swine wastewater, source-separated human urine, industrial wastewater, anaerobically pretreated domestic wastewater, slaughterhouse wastewater, filtered pig manure wastewater, anaerobic swine lagoon liquid, and supernatant of anaerobically digested sludge. The main drawbacks that these existing systems for struvite precipitation suffer from are with respect to production of struvite fines. These fine precipitates take a long time to grow in size and therefore affect settling time. Some processes can have a retention time of 10-14 days, which is too long and will affect the process economics. Other processes use energy intensive designs such as a fluidized bed reactor for struvite removal. Existing techniques have limitations such as the need for large reactor volumes, complicated designs, higher capital and operating and maintenance costs. They are also only able to remove about 90% phosphate which does not necessarily meet strict governmental EPA standards. To address these issues, a number of reactor designs have been studied in the past for precipitation of struvite from such wastewaters.

Large scale plants including those located at Italy (Treviso), USA (Crystalactor) and Canada (Ostara) primarily employ a fluidized bed reactor for struvite precipitation. The two important stages in formation of mineral precipitates from wastewater are nucleation and crystallization. Struvite precipitation process has the following common scheme that has been tailored in various ways by different researchers: (1) addition of required dosage of chemicals for supersaturation in order to promote nucleation; (2) adjustment of pH either by addition of alkali or aeration in order to provide optimal conditions for struvite precipitation; and (3) addition of a seed material or provision of a surface for crystal growth that causes settling.

In the Ostara (Peral) process, a fluidized bed reactor (FBR) is used to recover struvite in the form of pellets, 1.5-3.5 mm in diameter. The nutrient rich feed is fed to the reactor and known amount of chemicals are added and the pH is adjusted by addition of alkali (NaOH). Struvite fines are formed that act as seed material which are fluidized in the reactor till they grow in size (1-3.5 mm in diameter) following which they are harvested from the bottom end of the reactor.

In Japan's Shimane plant, a two zone reactor is employed for recovery of struvite. The first zone allows crystal nucleation while the second one is used for crystal growth and settling. The fines suspended in the settling zone are recycled back to zone one to act as seed material to enhance the nucleation process.

In the Crystalactor plant and the Treviso sewage works plant, sand particles are used as seed to allow growth of struvite crystals and improve settling in the reactor. Fluidized bed reactors have been preferred for chemical precipitation due to their ability to promote crystal growth and control particle size distribution.

All of the current reactor designs suffer from several significant drawbacks. For example, with current large scale plants, it is critical to control the hydrodynamic behavior such as initial contacting and mixing in FBRs, as reactants tend to follow preferential mixing path, thus hindering complete mixing conditions inside the reactor. In addition, large scale P recovery processes such as the PHOSNIX process employed in Japan, use long hydraulic retention times in the range of 10-14 days, to obtain large crystals that cause faster settling and result in greater than 90% P removal. Finally, studies have shown that use of shorter hydraulic retention time results in fine suspended particles being entrained in the reactor liquid and removed before struvite crystallization occurs.

Studies by Wang and Burken (2003) investigated the use of quartz, granite chips, and struvite crystals or fines as seeding material as well as mixing strengths for promoting struvite crystal growth and settle-ability using such seed material. They conducted experiments at pH 9.0 using various mixing intensities achieved by varying aeration rate (200, 300, 400 ml/min of air bubbles) and using 0.5 g of seed material. It was concluded that struvite fines, 75-150 μm in size, were most effective as a seeding material for struvite precipitation. However, it was also shown that use of larger sized seeding material resulted in higher P removal. It was suggested that though smaller seed material provided more surface area, due to its lower specific gravity, they tend to remain suspended in solution rather than settle down, thus hindering the ability to collect precipitated struvite.

Accordingly, a need exists for a reactor that can efficiently recover from stillage nutrients via struvite precipitation.

### BRIEF SUMMARY OF THE INVENTION

The subject invention provides a system and method for the efficient removal of phosphorous and nitrogen nutrients from wastewaters via struvite precipitation. Wastewater streams that can be treated using the subject process include municipal wastewater; wastewater generated by industrial power plants; and dairy, poultry and agricultural wastewater, including manure produced from livestock agricultural run-off that maybe be contaminated with fertilizers.

An object of the invention is to provide a feasible and more efficient system and method of struvite precipitation from feedstock. It is a further object of the present invention is the use of a single sequential batch reactor for recovery of phosphorous and nitrogen nutrients via struvite precipitation from wastewaters, preferably cellulosic stillage and/or dairy manure. More preferably, the feedstock is raw and anaerobically digested cellulosic ethanol stillage or dairy manure.

Another object is to provide a system and method for batch processing of stillage solids to enhance settling of struvite particles. It is a further object to provide a system and method that allows for quick time removal of phosphorous and nitrogen nutrients and settling of struvite particles. It is a further object to provide a system and method that allows for quick time settling of struvite particles. Yet a further object of the invention is to provide a system method that allows for quick struvite reaction time, preferably less than 1 to 2 hour reaction time and more preferably less than 30 minute reaction time.

Another object is to provide eco-friendly materials high in nutrient content, especially nitrogen and phosphorous nutrients, with agronomic properties for use as soil amendment. It is a further object of the invention to provide materials high in phosphorous and nitrogen nutrients that require little to no processing following collection from system of the subject invention for use as soil amendment. Yet a further object of the invention is to provide a process design using a sequential batch reactor with which more than 99% of P can be recovered as struvite.

Another object is to provide a method for seeding a sequential batch reactor of the invention with stillage solids to allow for faster struvite settling time in the order of minutes, as opposed to days that occurs in existing techniques. Yet a further object is to provide a limited aeration time, preferable limited to up to 2 hours aeration time, which allows for lower energy consumption compared to a typical fluidized bed reactor design.

### BRIEF DESCRIPTION OF THE DRAWINGS

FIG. 1 illustrates a schematic diagram of a sequential batch reactor according to the subject invention.

FIG. 2 is a photograph of an example of a small scale sequential batch reactor of the subject invention.

FIG. 3 is a schematic diagram of the four stages of treatment that occur in one single reactor in a sequential manner.

FIG. 4 illustrates a schematic diagram of the settle-ability of processed stillage from anaerobically digested stillage effluent seeded with stillage solids in accordance with the subject invention.

### DETAILED DESCRIPTION OF THE INVENTION

### Abbreviations and Definitions

AD refers to anaerobically digested.

COD refers to chemical oxygen demand.

FBR refers to fluidized bed reactor.

N refers to nitrogen.

P refers to phosphorous.

SBR refers to sequential batch reactor.

TSS refers to total suspended solids.

The present invention generally relates to a process for recovering nutrients in a reusable form from waste streams. According to the invention, systems and methods are provided for the efficient removal of phosphorous and nitrogen nutrients from wastewaters via struvite precipitation. More preferably, the subject invention relates to systems and methods for processing cellulosic stillage generated from ethanol production and/or wastewater from agricultural operations like dairy manure. Even more preferably, the systems and methods of the invention process anaerobically digested cellulosic ethanol stillage and/or anaerobically digested dairy manure to generate struvite precipitate.

According to the subject invention, a sequential batch reactor is provided for processing wastewater. As used herein, the terms “wastewater” and “waste stream” can refer to water to be treated such as streams or bodies of water from residential, commercial, or municipal, industrial, and agricultural sources, as well as mixtures thereof, that typically contain at least one undesirable species, or pollutant, comprised of biodegradable, inorganic or organic, materials which can be decomposed or converted by biological processes into environmentally benign or at least less objectionable compounds. The water to be treated can also contain biological solids, inert materials, organic compounds, including recalcitrant or a class of compounds that are difficult to biodegrade relative to other organic compounds as well as constituents from ancillary treatment operations.

In some embodiments, the wastewater may be water generated in municipal waste water treatment plants or at food processing plants, such as at dairy and cheese processing plants. In other embodiments, the wastewater may be from agricultural sources such as livestock. As used herein, the term “livestock” refers to all domesticated animals, including horses, swine, all varieties of cattle such as dairy cows, steer, yak, goats, or any animals whose waste is subject to dilution with water for conveyance or processing.

In certain embodiments, the wastewater can include any raw or treated (for example treatment methods could include physical treatment like settling, filtration, dissolved air flotation or membrane separation; aerobic treatment; or anaerobic digestion) wastewater containing phosphate (PO₄3−, H₂PO₄−, HPO₄2−, H₃PO₄).

In a specific embodiment, a sequential batch reactor is provided for processing raw ethanol stillage or dairy manure. Ethanol production consists of feedstock preparation; liquefaction which dissolves the feedstock into solution; enzyme conversion to sugar; fermentation of the sugar into ethanol; separation of ethanol from the distillers wet grains or “raw stillage” (residual liquids and solids); and subsequent management of the raw stillage. With “raw stillage,” the stillage solids are not separated from the liquid. According to the subject invention, the term “cellulosic stillage” or “ethanol stillage” refers to feedstock generated from the processing of any cellulosic substrate such as wood, corn, beans, sugar cane, sugarcane straw, wheat grass, wheat straw, barley straw, sorghum, rice grass, bagasse, switchgrass, corn stover, corn fiber, grains, or a combination thereof. One common strategy for managing raw stillage is via anaerobic digestion.

In a related embodiment, the sequential batch reactor can process anaerobically treated ethanol stillage or anaerobically treated dairy manure. Preferably, the sequential batch reactor processes raw and/or anaerobically treated cellulosic ethanol stillage. In certain embodiments, the anaerobically treated cellulosic ethanol stillage may be obtained from common anaerobic reactors including, but not limited to, continuous stirred tank reactors (CSTRs), upflow anaerobic sludge blanket reactors, downwards stationary fixed film reactors and fluidized bed reactors. The anaerobic digestion of stillage or dairy manure may be conducted under mesophilic and/or thermophilic conditions. In a preferred embodiment, the wastewater that can be fed into the sequential batch reactor of the subject invention is obtained from an anaerobic reactor, more preferably a fluidized bed reactor or sludge blanket reactor performing anaerobic digestion under thermophilic conditions (between about 50°−60° C., preferably 55° C.) or mesophilic conditions. Anaerobic digestion produces a liquid rich in ammonia, biogas containing a sulfur byproduct (such as H₂S). In certain embodiments, coarsely sieved stillage or dairy manure (devoid of solids) that has been anaerobically treated is processed according to the subject invention by struvite precipitation to recover nutrients. In alternate embodiments of the invention, effluent from anaerobically digested stillage and dairy manure, preferably anaerobically digested coarsely sieved raw cellulosic ethanol stillage or dairy manure, is processed via struvite precipitation to recover nutrients.

The raw stillage or dairy manure may include stillage or dairy manure that has passed through one or more screens or sieves, e.g., a screen having an average opening size of 2 mm or less, preferably 1 mm or less and even more preferably 0.5 mm or less. Screening or sieving separates the material according to size to produce stillage or dairy manure that can be processed according to the subject invention.

In one embodiment of the invention, during startup, a sequential batch reactor is filled with wastewater, preferably raw and/or anaerobically treated ethanol stillage or dairy manure, and is seeded with a biomass Generally, any biomass material that is or includes carbohydrates composed entirely of one or more saccharide units or that include one or more saccharide units can be used to seed a sequential batch reactor as described herein. For example, the biomass material can be cellulosic or lignocellulosic materials, or starchy materials, such as kernels of corn, grains of rice or other foods, or materials that are or that include one or more low molecular weight sugars, such as sucrose or cellobiose.

In a preferred embodiment, the sequential batch reactor is seeded with fibrous biomass, preferably cellulosic or lignocellulosic biomass. Fibrous cellulosic sources include paper and paper products (e.g., polycoated paper), and fibrous lignocellulosic sources include wood and wood-related materials (e.g., particle board). Other suitable fiber sources include natural fiber sources, e.g., grasses, rice hulls, bagasse, cotton, jute, hemp, flax, bamboo, sisal, abaca, straw, corn cobs, rice hulls, coconut hair; fiber sources high in α-cellulose content, e.g., cotton; and synthetic fiber sources, e.g., extruded yarn (oriented yarn or un-oriented yarn). Natural or synthetic fiber sources can be obtained from virgin scrap textile materials, e.g., remnants or they can be post-consumer waste, e.g., rags. When paper products are used as fiber sources, they can be virgin materials, e.g., scrap virgin materials, or they can be post-consumer waste. Aside from virgin materials, post-consumer, industrial (e.g., offal), and processing waste (e.g., effluent from paper processing) can also be used as fiber sources. Also, the fiber source can be obtained or derived from human (e.g., sewage), animal or plant wastes. Additional fiber sources have been described in U.S. Pat. Nos. 6,448,307, 6,258,876, 6,207,729, 5,973,035 and 5,952,105.

In one embodiment, the reactor is seeded with between 1%-15% (wet w/v) stillage solids from anaerobically digested stillage. More preferably, the reactor is seeded with between 1%-10% (wet w/v) stillage. Preferably, the stillage used to seed the reactor is from stillage solids collected after sieving, as described above, and prior to anaerobic digestion. More preferably, the stillage is fibrous biomass of a size at about 0.5 mm in thickness.

Once the sequential batch reactor is filled and seeded, the pH is adjusted using sodium hydroxide and/or magnesium chloride. The ideal pH of the stillage and seed is preferably between 8.0-10 pH, more preferably between 8.5-9.5 pH, and even more preferably between 8.5—is achieved in within the 9.0. In a preferred embodiment, the pH of within the sequential batch reactor for struvite precipitation is 8.9 pH. The dosage requirements of magnesium chloride and sodium hydroxide are preferably determined using chemical equilibrium models.

Once the preferred pH is achieved within the reactor, small amounts of air or oxygen may be injected into the reactor by adding a controlled flow rate of compressed air or oxygen. In some instances, especially with anaerobically digested dairy manure, the pH can be adjusted by sparging air. In certain embodiments, the contents of the reactor are mixed by sparging air through the bottom of the reactor. Alternatively, the contents of the reactor can be mixed by sparging air through the top or at any location within the reactor. According to the subject invention, aeration is performed for about 1 hour, preferably less than 1 hour, and even more preferably aeration is performed for half an hour.

Following reaction and mixing of reactor contents via aeration, the reacted products are allowed to settle in a quiescent state with aeration being turned off. Struvite precipitated during the reaction and mixing is allowed to settle to the bottom of the reactor. According to the subject invention, processed sludge including struvite precipitate is collected within 5 minutes, 10 minutes, 15 minutes, half an hour, 45 minutes, one hour, four hours, twenty-four hours and seventy two hours of ceasing aeration. Preferably, processed sludge is collected within 5-45 minutes of ceasing aeration. Following processed sludge collection, the sludge can be further treated prior to application for soil amendment (such as drying at 105° C.).

In certain embodiments, more than 95% of settling occurred within the first 15 minutes of undisturbed settling following the 30 min reaction time. About 99.9% and 56% orthophosphate-phosphorous and ammonia-nitrogen, respectively, were removed from anaerobically digested cellulosic ethanol stillage via struvite precipitation. Seeding also increased the yield of settled sludge-containing struvite precipitate by 63%. Struvite-containing settled sludge obtained from processing raw stillage was also investigated for its agronomic and environmental efficiency and nutrient leachability. In certain embodiments, processed sludge of the subject invention improved nutrient uptake by plants and reduced N and P levels in leachate on application of processed sludge as soil amendment for cultivation of sweet sorghum (S. Agyin-Birikorang, G. A. O'Connor et al. 2013)

### Example 1

### Materials and Methods

Feed Wastewater: struvite precipitation and recovery were carried out on two wastes:
Raw cellulosic ethanol stillage, and
Anaerobically digested stillage.
   Stillage was coarsely sieved for solid-liquid separation and anaerobically digested in a fluidized bed reactor under thermophilic conditions (Mohan 2012). The “anaerobically digested stillage” was the digested stillage effluent obtained from the fluidized bed reactor.

### Reactor Design:

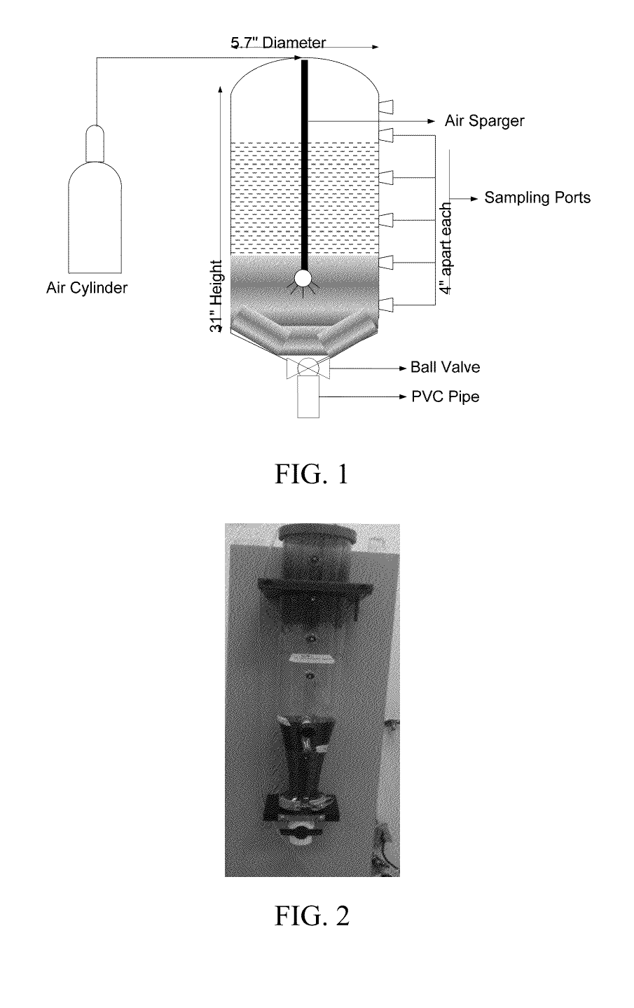

Struvite precipitation from stillage was carried out in a cylindrical PYREX glass reactor (7 L) with a conical base (2 L). The schematic representation and a photograph of the sequential batch reactor are presented in FIG. 1. The reactor was 31″ in height and 5.7″ in diameter and was equipped with 6 different sampling ports at 3.5″, 7.5″, 11.5″, 15.5″, 20.5″ and 24.5″ from the top of the reactor, respectively, for sample collection. The reactor was covered with a plastic lid equipped with 3 ports for air inlet, feed supply and sample collection. The settled solids were drained from the bottom of the reactor that was attached to a PVC pipe fitted to a ball valve via an O-ring.

### Reactor Operation:

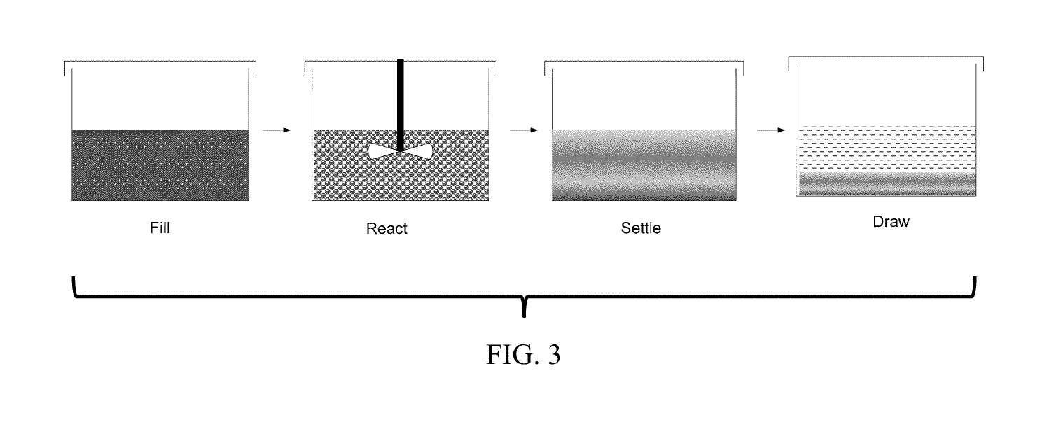

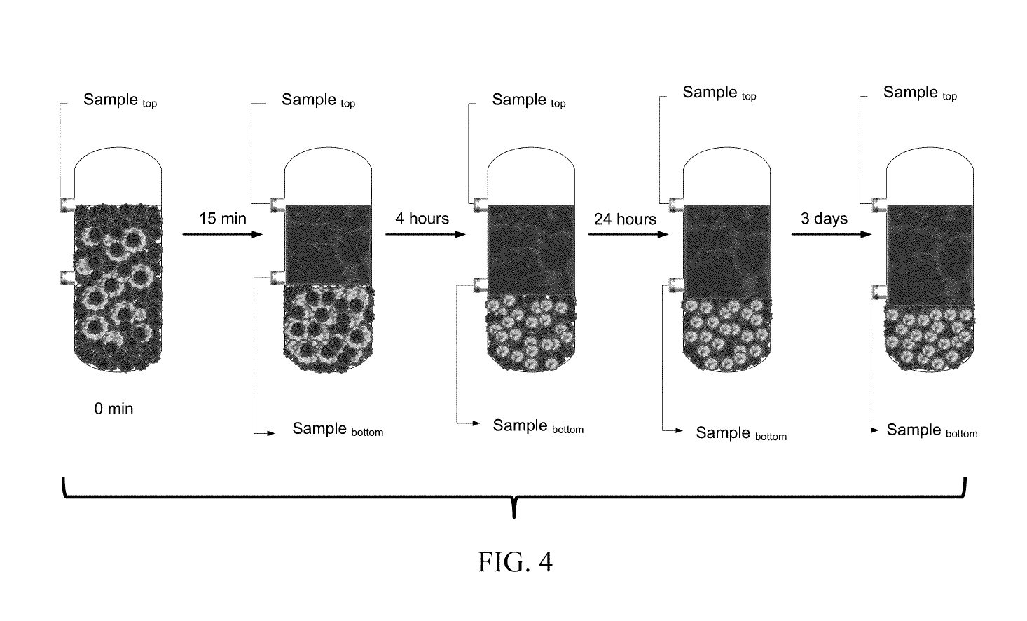

As shown in FIG. 2, in a sequential batch reactor (SBR), all four stages; fill, react, settle and draw, occur in one single reactor in a sequential manner. Stillage was processed in the sequential batch reactor shown in FIG. 3. The reactor was filled with 8 L of cellulosic ethanol stillage (raw or digested) and the pH was adjusted to 8.9 using SN sodium hydroxide, the optimum for struvite precipitation (Gadekar and Pullammanappallil, 2010). The dosage requirements of magnesium chloride and sodium hydroxide were determined using a chemical equilibrium model developed to determine the yield and purity of struvite precipitated from various wastewaters (Mohan et al., 2011). The contents were mixed by sparging air through the bottom of the reactor and struvite precipitation reaction was allowed to proceed for 30 minutes. At the end of the reaction time, air was turned off and the precipitate and other solid organic matter in the stillage were allowed to settle.

When raw stillage was used as feedstock, following the 30 minute reaction time solids were allowed to settle down for 24 hours and then the supernatant was decanted and the settled sludge was used for agronomic studies. In this experiment, stillage solids were not separated from the liquid prior to struvite precipitation. So, the resulting settled material included organic materials and other constituents contained in the raw stillage. Therefore, the settled sludge does not qualify as a pure struvite, rather is struvite containing sludge and shall be referred to herein as ‘processed sludge.’

Struvite precipitation from anaerobically digested stillage was carried out in three ways.
From coarsely sieved stillage (devoid of stillage solids) that was anaerobically digested,
From anaerobically digested stillage seeded with 1% (wet w/v) stillage solids and
From anaerobically digested stillage seeded with 10% (wet w/v) stillage solids.

The stillage solids collected after sieving prior to anaerobic digestion were used in the second and third treatments. The coarse solids were added to the reactor along with stillage prior to aeration. After 30 minutes of reaction time, the processed sludge was allowed to settle. Samples were collected at 0, 0.25, 4, 24 and 72 hour periods, respectively, from top of the reactor and just above the interface of settled solids and liquid, and analyzed for ammonia, phosphate concentrations and total suspended solids. Struvite containing sludge collected from the bottom of the reactor was also analyzed for total suspended solids content. Ammonia-nitrogen was analyzed using the Hach test kit and phosphate was analyzed using the ascorbic acid method described in the 18^{th} edition of the Standard Methods book (APHA, 1992). Total solids content was determined by drying the samples at 105° C. in an oven for overnight. The pH was measured using an Orion benchtop pH meter.

All the above experiments were carried out in duplicates and the reported values are average of the results obtained from the repeat experiments.

### Characterization of Cellulosic Ethanol Stillage:

Raw stillage and anaerobically digested stillage were analyzed for ammonia nitrogen and orthophosphate phosphorous content. Raw stillage obtained from the Biofuels plant had a pH of 6.2 and NH₃—N and PO₄—P concentrations of 265±35 and 779.5±29.5 mg/L, respectively (Table 1). The total solids concentration of raw stillage was 12±2.03%. This was used in part 1 of this study as whole stillage without solid separation. In the agronomic studies carried out by Agyin-Birikorang, et al. (2012) on processed sludge (which was the settled sludge containing organic compounds as well as the mineral precipitates) was collected together and used as soil amendment.

TABLE 1
Characterization of Feedstock

| | | Anaerobically |
|---|---|---|
| Parameter | Raw Stillage | Digested Stillage |
| pH | 6.2 ± 0.3 | 7.7 ± 0.8 |
| Ammonia Nitrogen (mg/L) | 265 ± 35 | 302 ± 17.5 |
| Orthophosphate Phosphorous (mg/L) | 779.5 ± 29.5 | 559 ± 32 |
| *Mg Required (mg/L) | 350 | 450 ± 75 |
| *Alkali Required (g/L) | 2.3 | 1.06 |

*Determined using mathematical model as described in Mohan et al., “Development of a Process Model for Recovery of Nutrients from Wastewater by Precipitation as Struvite,” Florida Water Resources, pp. 17-22 (2011), which is incorporated herein by reference in its entirety.

Although struvite precipitation from raw stillage helps recover N and P, the high soluble COD of the waste is not affected in the process. Therefore, in certain embodiments, additional biological treatment methods such as anaerobic or aerobic treatment may be implemented post struvite precipitation. Such a post biological treatment would also require addition of nutrients for microbial growth.

According to the subject invention, a preferred embodiment is directed to anaerobically digesting high strength wastewater prior to recovering the excess nutrients. Anaerobic digestion of coarse separated stillage was carried out in a fluidized bed reactor to convert the soluble its high organic content into biogas. The anaerobic effluent had a pH of 7.7±0.8 and NH₃—N and PO₄—P concentrations of 302±17.5 and 559±32 mg/L, respectively. The total solids content of the coarse separated stillage influent and anaerobically digested effluent were 4±0.1% and 2±0.4%, respectively.

Struvite Sludge from Raw Stillage:

Struvite precipitation was carried out using 8 L of raw whole stillage in a SBR. After allowing the processed sludge to settle for a period of 24 hours, the supernatant was decanted and the solids were collected form bottom of the reactor. Mineral composition of raw stillage and processed sludge was analyzed at the Soil and Water Science department at the University of Florida. Stillage obtained from the Biofuels pilot plant was acidic in nature with a pH of 6.42±0.86. Gadekar (2010) studied the significance of pH to obtain higher yields of struvite from various wastewaters. Based on his work, the pH was raised from 6.42±0.86 to 8.9 using 5N sodium hydroxide.

A chemical equilibrium model based on charge and mass balances developed by Gadekar (2010) used to predict the yield and purity of struvite precipitated from wastewater streams was used to determine the amount of alkali and magnesium required to recover N and P as struvite. Using this model it was determined that 2.3 g/L of NaOH and 350 mg/L of magnesium would be required to precipitate N and P from stillage as struvite (Mohan et al., 2010). The initial N and P concentrations in raw stillage were 65.8±5.68 and 35.2±34.3 g (Kg stillage)-1, respectively. Among the total N, individual ammonia, nitrate and organic N concentrations were determined to be 23.6±3.01, 33.6±3.62 and 10.1±0.94 g Kg-1 of raw stillage, respectively. Elemental analysis was also carried out on cellulosic ethanol stillage by Agyin-Birikorang, et al. (2012). Iron, Aluminum, Potassium, Calcium, Magnesium and Sulfur content of raw stillage is listed in Table 2.

TABLE 2
Characterization of processed stillage for
use as soil amendment*

| Property | Processed stillage |
|---|---|
| pH | 8.71 ± 0.38 |
| Solids (%) | 28.0 ± 3.14 |
| Nitrogen (g kg⁻¹) | 69.2 ± 7.24 |
| Ammonium-N (g kg⁻¹) | 25.2 ± 3.14 |
| Nitrate-N (g kg⁻¹) | 35.3 ± 4.02 |
| Organic N (g kg⁻¹) | 9.74 ± 1.02 |
| Total iron (g kg⁻¹) | 0.21 ± 0.03 |
| Total aluminum (g kg⁻¹) | 0.11 ± 0.02 |
| Total P (g kg⁻¹) | 34.3 ± 1.84 |
| WEP (g kg⁻¹) | 0.29 ± 0.01 |
| PWEP (%) | 0.16 ± 0.02 |
| Mehlich-3 P (g kg⁻¹) | 18.2 ± 1.98 |
| Mehlich-3 K (g kg⁻¹) | 4.58 ± 0.62 |
| Mehlich-3 Ca (g kg⁻¹) | 0.96 ± 0.04 |
| Mehlich-3 Mg (g kg⁻¹) | 8.98 ± 1.02 |
| Elemental S (g kg⁻¹) | 7.04 ± 0.92 |

*Reference: Agyin-Birikorang, et al. (2012)

Following the characterization of waste feedstock, stillage was subjected to struvite precipitation in a SBR. After 30 minutes of reaction time, the processed sludge was allowed to settle for ˜1 hour. Samples were collected from the settled sludge that constituted for ˜35% of the initial total volume of wastewater fed into the reactor and were analyzed for percent solids, N, P, ammonia, nitrate, organic N and elemental composition. The total suspended solids content of settled processed sludge collected from the bottom of the reactor was 28±3.14%. A mass balance on NH₃—N and PO₄—P shows that about 76% (NH₃) and 86.5% (PO₄) were recovered in the processed sludge leaving behind a residual 23% (NH₃) and 14.5% (PO₄) nutrient concentration in the supernatant. Although 86.5% of P was recovered in the process, the major obstacle in carrying out this procedure lies in obtaining complete mixing via aeration. Due to the presence of stillage solids, much difficulty was faced during aeration as well as sludge collection and reactor clean up, as the sludge tends to clog up the sample collection ports.

The processed sludge collected at the end of 1 hour settling period was used in a greenhouse study conducted by Agyin-Birikorang (2012), at the Soil and Water Science department at the University of Florida, on sweet sorghum, a bioenergy crop. This study was carried out to investigate the agronomic and environmental effectiveness of application of raw stillage versus processed sludge as soil amendment.

Struvite Sludge from Anaerobically Digested Stillage:

Tian (2011) showed that 70% of the methane potential of whole stillage is generated from stillage filtrate that is obtained post separation of the fibres or solids from whole stillage (Tian 2011). Therefore, in this study stillage solids were separated by passing whole stillage through a 0.425 mm sieve and the solids retained in the sieve were stored for later use. 2 L of anaerobically digested stillage was filled in the SBR, pH was adjusted from 7.7 to 8.9 using 2.3 g/L of NaOH, 350 mg/L of Mg was added as MgCl2.6H2O (determined using the model) and the mixture was aerated for 30 minutes and allowed to settle for 24 hours prior to sample collection and analysis. The supernatant had 55.85±1.2 and 41.9±3.7 mg/L of ammonia and phosphate, respectively. The processed sludge contained precipitated struvite and was collected at the bottom of the reactor for total suspended solids analysis. About 2.25±0.2 g/L struvite containing sludge was produced from these experiments. The results from the model used to determine the yield of struvite agreed well with the experimental results. The error between the model predictions and measured total suspended solids was 12.6%. However, one obstacle that had to be overcome in this process was the production of fines that caused hindered settling and therefore need for an additional separation phase.

In previous studies, use of quartz, granite chips and struvite fines as seed material has been investigated to study their effect on crystal growth and settling. Wang and Burken (2003) showed that addition of seed material enhanced P-removal via struvite precipitation up to 23-83%. While granite performed poorly at low mixing intensities (200 ml air/min), sand and struvite fines were shown to have performed equally good at any given mixing intensity. Contrary to the idea that large seeds perform poorly as a seeding material due to smaller available surface area, it was shown that P removal was higher with larger seed size at any given mixing intensity.

In this study addition of small amounts of stillage solids as seed was investigated for improved settling of processed sludge. The top port of the reactor was used to collect samples of the supernatant, the bottom port was used to collect liquid samples from the liquid-settled solids interface and processed sludge was collected at the bottom end of the reactor. The first experiment was conducted without any seed. In the second experiment, 1% (wet w/v) stillage solids were used as seed in struvite precipitation trials. In the third set of experiments, 10% (wet w/v) solids were used as seeding material. In all the trials, samples were collected at 0, 0.25, 4, 24 and 72 hours and analyzed for residual NH₃—N, PO₄—P and TSS. Table 3 lists the results of residual NH₃—N, PO4P and TSS measured at the end of struvite precipitation process for 0%, 1% and 10% seeded experiments, respectively. The total suspended solids settled at the bottom end of the reactor was 63±3.5% higher in case of seeded experiments as compared to processed sludge from unseeded AD stillage trials. The percent increase in solids was calculated after subtracting the amount of stillage solids added to AD stillage. Thus any increase in TSS would correspond to precipitated minerals. Correspondingly, residual phosphate content in the supernatant was reduced to 41.9±3.7%, 0.3±0.05%, 2.7±0.2% in the 0%, 1% and 10% seeded experiments.

TABLE 3
Nutrient Recovery from Anaerobically Digested Stillage

| | AD Stillage + | AD Stillage + | AD Stillage + |
|---|---|---|---|
| Parameter | 0% seed | 1% seed | 10% seed |
| Residual NH₃—N | 55.8 ± 1.25 | 153 ± 6.2 | 160 ± 7.2 |
| (mg/L) | | | |
| Residual PO₄—P | 41.9 ± 3.7 | 0.3 ± 0.05 | 2.7 ± 0.2 |
| (mg/L) | | | |
| Total Suspended | 2.25 ± 0.2 | 5.6 ± 0.25 | 6.8 ± 0.75 |
| Solids (g/L) | | | |

Results on P-removal show that about 99.7±0.2% of phosphate was removed at the end of struvite precipitation process on adding stillage solids compared to 94.6% P-removal from AD stillage without solids. Results obtained in the present study were in good agreement with observations made by Wang and Burken (2003) on seeding the struvite precipitation process. In the present study, due to production of fines form the unseeded experiments that showed poor settling, a post filtration step was required even after 24 hours of settling time. In the subsequent experiments, use of stillage solids helped overcome this limitation. Although mixing strength was maintained constant, the amount of seed material was varied to determine an optimum amount of seed that could promote crystal growth and settle-ability.

Results from Tables 4 and 5 present the data on N and P removal. It can be seen that the difference in P or N removal were not significantly different for 1% and 10% (wet w/v) seeded experiments. Supernatant samples collected from the top port in case of both 1% and 10% seeded experiments had a TSS content of ˜1-1.2% after 15 min of settling and showed no further change even after 3 days. Samples collected from the bottom port near the liquid-settled sludge interface also had a TSS content of ˜1±0.1% in samples analyzed at 15 min, 4 hr, 24 hr and 3 days. This showed that about 95% of settling occurred within the first 15 minutes showing that use of seed material improved settle-ability of the processed sludge. Data in Tables 4 and 5 also list the residual NH₃—N and PO₄—P concentrations of the supernatant samples collect from the two ports at different settling times. In 1% seeded experiments, residual phosphate and ammonia levels were reduced to <0.1 mg/L and 160 mg/L, respectively, after 15 minutes of settling and remained unchanged after this period. While, in the case of 10% seeded experiments, although the final phosphate and ammonia levels were comparable with the former, it took about 3 days to achieve these concentrations.

TABLE 4
Characterization of Processed Stillage from AD stillage + 1%
(wet w/v) stillage solids

| Settling time | Sampling | NH₃—N | PO₄—P | TSS |
|---|---|---|---|---|
| (hours) | location | (mg/L) | (mg/L) | (%) |
| 0 | Top | 180 | 38.5 | 1.16 |
| 0.25 | Top | 160 | 0.3 | 1.01 |
| 4 | Top | 140 | 0.593 | 1.001 |
| 4 | Bottom | 140 | <0.1 | 1.001 |
| 24 | Top | 160 | 0.297 | 0.85 |
| 24 | Bottom | 150 | <0.1 | 1.03 |
| 72 | Top | 140 | <0.1 | 0.97 |
| 72 | Bottom | 160 | <0.1 | 1.01 |

*The values presented here are average of duplicate runs with standard deviation was <10%.

TABLE 5
Characterization of Processed Stillage from AD stillage + 10% (wet w/v)
stillage solids

| Settling time | | NH₃—N | PO₄—P | TSS |
|---|---|---|---|---|
| (hours) | Sampling location | (mg/L) | (mg/L) | (%) |
| 0 | Top | 170 | 61.9 | 1.61 |
| 0.25 | Top | 210 | 77.7 | 1.22 |
| 4 | Top | 180 | 23.1 | 1.14 |
| 4 | Bottom | 190 | 30.1 | 1.16 |
| 24 | Top | 180 | 18.8 | 1.15 |
| 24 | Bottom | 190 | 16.2 | 1.11 |
| 72 | Top | 130 | 2.7 | 1.07 |
| 72 | Bottom | 160 | 2.95 | 1.12 |

*The values presented here are average of duplicate runs with standard deviation was <10%.

Kim et al., (2006) studied the use of varying quantities of seed for enhancing struvite precipitation. Preformed struvite crystals at concentration varying from 0 g/l to 40 g/l were investigated for use as seed. It was speculated that while at lower seed concentrations, struvite precipitation proceeded primarily via crystal nucleation and then crystal growth, at higher seed concentrations, the latter was more dominant. So, it can be hypothesized that while nucleation followed by crystal growth is the mechanism of struvite precipitation in 1% seeded experiments, the process shifts more towards crystal growth in case of 10% seeded experiments. Although no significant difference was observed with respect to settling in either case, P recovery was faster in 1% seeded experiments. Therefore, it can be concluded that addition of 1% (wet w/v) seed was enough to cause 99.9% P removal, 56% N removal and promote crystal growth and faster settling (95%) within 15 minutes.

### Agronomic Efficiency of Processed Sludge Containing Struvite:

Results from greenhouse studies conducted out by Agyin-Birikorang et al., (2012) on application of raw stillage vs. processed sludge as soil amendment for cultivation of sweet sorghum has been discussed in this section.

The agronomic and environmental effectiveness of the raw stillage and processed sludge as potential plant nutrient sources were compared to inorganic fertilizers (ammonium nitrate+triple superphosphate), biosolids and manure. Two biosolids (Gainesville Regional Utilities (GRU) biosolids and Milorganite biosolids) of different phytoavailability, and poultry manure were selected for the study (Agyin-Birikorang et al., 2009; Chinault and O'Connor, 2008; Miller and O'Connor, 2010). The GRU biosolids was obtained from the water reclamation facilities of the Gainesville Regional Utilities (Gainesville, Fla.) and was produced through aerobic digestion. The GRU biosolids had a high soluble P content (˜7 g kg⁻¹). Milorganite biosolids, obtained from Milwaukee Metropolitan Sewerage District, Milwaukee, Wis., was generated from anaerobically digested material that was heat-dried and pelletized. Milorganite has a low soluble P content (˜0.1 g kg⁻¹). Milorganite biosolids was stabilized with iron salts to decrease its P solubility. Poultry manure utilized for the study was obtained from an egg producing farm in Indiantown, Fla.

The nutrient sources were mixed with 4 kg of soil (Horizon Immokalee) at the recommended N application rate of 150 kg PAN ha-1 for sweet sorghum (Mylavarapu et al., 2007). The plant available N (PAN) was calculated based on the inorganic N content of the nutrient sources, and an assumed mineralization of the organic N content. The stillage-manure- and biosolids-amended soils were equilibrated (˜80% water holding capacity) in zip-lock plastic bags for 2 weeks in the laboratory prior to use in the greenhouse.

Nitrogen uptake efficiency was found to be similar between the treatments with inorganic fertilizer (0.35 g g⁻¹) and the processed stillage (0.36 g g⁻¹). The N uptake efficiency of both treatments was shown to be greater than that of the manure (0.31 g g⁻¹), the Milorganite biosolids (0.29 g g⁻¹) and GRU biosolids (0.28 g g⁻¹). The least N uptake efficiency of ˜0.27 g g⁻¹ occurred in the treatment with the raw stillage material. Results from this study showed that processing raw stillage increased N uptake efficiency by an average of ˜0.95 g g⁻¹ compared to raw stillage when applied as soil amendment.

Phosphorus uptake efficiency of the processed stillage treatment (˜0.43 g g⁻¹) was statistically similar to the P uptake efficiency of the inorganic P fertilizer and the organic nutrient sources (ranging between ˜0.40 g g⁻¹ and ˜0.44 g g⁻¹). Similar to N uptake efficiency, P uptake efficiency of the processed sludge containing struvite was significantly greater than that of the raw stillage. Processing the raw stillage, thus, improved the efficiency of the material in releasing nutrients to the plants, compared to the raw stillage.

### Amount of Nitrogen and Phosphorus in Leachate:

Improved N and P uptake efficiency, through the use of processed sludge significantly reduced masses of N and P lost via leaching. Without processing, ˜55 mg of the N applied from the raw stillage leached out. Processing of stillage however reduced the mass of N leached from ˜55 mg to ˜32 mg. These results are in agreement with work done by Ren et al. (2010) who showed that total N loss was reduced from 35% to 12%, when struvite was used as a nutrient source relative to unamended control.

Consistent with P uptake, a significant reduction in mass of P leached was observed when the processed sludge was used as the nutrient source. With the exception of the inorganic P source, application of the other nutrient sources (stillage, biosolids, and manure) at N-based rates resulted in differential total P application rates (189 kg P ha⁻¹ Raw- and 168 kg P ha⁻¹ for processed stillage; 154 kg P ha⁻¹ for GRU biosolids; 133 kg P ha⁻¹ for Milorganite biosolids; and 113 kg P ha⁻¹ for manure). The greatest percent P leached (˜51%), occurred with the raw stillage, followed by the inorganic nutrient source (49%), GRU biosolids (˜45%), and manure (˜36%), respectively. The least percentage of the applied P measured in the leachate (˜31%) occurred in the treatments that received processed sludge and Milorganite biosolids. The P leaching data were consistent with the calculated (PWEP) values (Table 2), and also consistent with the observations of Brandt et al. (2004) and Agyin-Birikorang et al. (2008) that PWEP values of P sources are strongly related to off-site P losses.

The operation of the experimental study using a single sequential batch reactor described above demonstrated the successful efficient recovery of N and P as struvite from raw and anaerobically digested cellulosic ethanol stillage. The results showed that use of 1% stillage solids as seed improved N and P removal, increased the yield of struvite containing sludge and positively impacted settling of processed sludge with more than 95% of settling occurring within the first 15 minutes.

Processing raw stillage also resulted in improved nutrient uptake efficiencies of N and P; 0.36 g/g and 0.4 g/g, respectively, that were comparable with that of inorganic fertilizers and much higher than results obtained from application of non-processed raw stillage as nutrient source for cultivation of sweet sorghum, a bioenergy crop. Application of processed stillage (sludge) as opposed to raw stillage as soil amendment reduced the mass of N and P lost due to leaching by 42% and 20%, respectively.

### Example 2

The wastewater used in the following Experiments 1-3 was anaerobically digested dairy manure. Anaerobic digestion of actual dairy manure was performed in a pilot scale anaerobic digester.

The effluent from the digester was treated for phosphate removal. Experiments on phosphorous removal were conducted on anaerobically digested effluent produced from different batches of dairy manure feed.

### Experiment 1

Using 10% seeding the total phosphorous concentration was measured at start. Reaction period was 2 hours. Then samples from supernatant were analyzed after 24 hours of settling of the treated effluent. Results summarized in Table 6 below.

TABLE 6
Measurement of total phosphorus following treatment

| | | End of 2 hours | End of 24 hours settling |
|---|---|---|---|
| | Initial | Reaction | (decanted Sample) |
| Total Phosphorus (mg/L) | 193.4 | 111.8 | 55.72 |

### Experiment 2

Using 0% seeding (i.e., no seeding) the total phosphorous concentration was measured at start. Reaction period was 2 hours. Then samples from supernatant were analyzed after 24 hours of settling of the treated effluent. Results summarized in Table 7 below.

TABLE 7
Measurement of total phosphorus following treatment

| | | End of 2 hours | End of 24 hours settling |
|---|---|---|---|
| | Initial | Reaction | (decanted Sample) |
| Total Phosphorus | 365.9 | 261.4 | 96.56 |
| (mg/L) | | | |

### Experiment 3

Using 10% seeding the total phosphorous concentration was measured at start. Reaction period was 2 hours. Then samples from supernatant were analyzed as the treated effluent allowed to settle. Magnesium (Mg), calcium (Ca) and potassium (K) were also measured. Results summarized in Table 8 below.

TABLE 8
Measurement of total magnesium, calcium, potassium and phosphorus

| Samples | Mg (mg/L) | Ca (mg/L) | K (mg/L) | P (mg/L) |
|---|---|---|---|---|
| Initial Digester | 449.2 | 1037.2 | 1404.4 | 338.52 |
| effluent samples | | | | |
| 2 Hours Settling | 1360.4 | 745.2 | 1648.8 | 167.4 |
| Following reaction | | | | |
| 6 Hours Settling | 386.2 | 155.44 | 388.96 | 35.04 |
| Following reaction | | | | |
| 20 Hours Settling | 409.2 | 100.88 | 434.8 | 24.96 |
| Following reaction | | | | |

It should be understood that the examples and embodiments described herein are for illustrative purposes only and that various modifications or changes in light thereof will be suggested to persons skilled in the art and are to be included within the spirit and purview of this application.

### REFERENCES

Altinbas, M., C. Yangin, and I. Ozturk. 2002. Struvite precipitation from anaerobically treated municipal and landfill wastewaters, Water Sci. Technol. 46:271-278.
Basakcilardan-Kabakci, S., A. N. Ipekoglu, and I. Talinli. 2006. Precipitation of magnesium ammonium phosphate from source-separated urine, ITU Dergisi 5:34-44.
Battistoni, P., G. Fava, P. Pavan, A. Musacco, and F. Cecchi. 1997. Phosphate removal in anaerobic liquors by struvite crystallization without addition of chemicals: preliminary results, Water Res. 31:2925-2929.
Brandt R C, Elliott H A, O'Connor G A (2004) Water extractable phosphorus in biosolids: Implications for land-based recycling. Water Environ. Res. 76:121-129.
Celen, I., M. Turker. 2001. Recovery of ammonia as struvite from anaerobic digester effluents, Environ. Technol. 22:1263-1272.
de-Bashana, L. E., Y. Bashana. 2004. Recent advances in removing phosphorus from wastewater and its future use as fertilizer (1997-2003). Water Research 38:4222-4246
Di-Iaconi, C., M. Pagano, R. Ramadori and A. Lopez. 2009. Nitrogen recovery from a stabilized municipal landfill leachate. Bioresource Technology 101:1732-1736
Diwani, G. E., Sh. E. Rafie, N. N. E. Ibiari, and H. I. El-Aila. 2007. Recovery of ammonia nitrogen from industrial wastewater treatment as struvite slow releasing fertilizer, Desalination 214:200-214.
Gadekar, S., and P. Pullammanappallil. 2010. Validation and Applications of a Chemical Equilibrium Model for Struvite Precipitation. Environ. Model. Asses. 15:201-209
Gadekar, S. 2012. Process Development For Recovery Of Nutrients As Struvite And Struvite Based Products. Agricultural and Biological Engineering. Gainesville, University of Florida. Ph.D.
Genz, A., A. Kornmuller, et al. 2004. Advanced phosphorus removal from membrane filtrates by adsorption on activated aluminium oxide and granulated ferric hydroxide. Water research 38(16): 3523-3530.
Gunay, A., D. Karadag, I. l Tosun, and M. Ozturk. 2008. Use of magnesite as a magnesium source for ammonium removal from leachate, J. Hazard. Mater. 156:619-623.
He, S., Y. Zhang, M. Yang, W. Du, and H. Harada. 2007. Repeated use of MAP decomposition residues for the removal of high ammonium concentration from landfill leachate, Chemosphere 66:2233-2238.
Kabdasli, I., P. Ozcan, and O. Tunay. 2003. Nitrogen removal by magnesium ammonium phosphate precipitation in slaughter-house wastewater, Su Kirlenmesi Kontrolu Dergisi 13:13-18.
Kalyuzhnyi, S., V. Sklyar, A. E. I. Arkhipchenko, I. Barboulina, O. Orlova, and A. Klapwijk. 2002. Combined biological and physico-chemical treatment of filtered pig manure wastewater: pilot investigations, Water Sci. Technol. 45:79-87.
Kim, D., H-D. Ryu, M-S. Kim, J. Kim, and S-Ill. Lee. 2007. Enhancing struvite precipitation potential for ammonia nitrogen removal in municipal landfill leachate, J. Hazard. Mater. 146:81-85.
Li, X. Z., and Q. L. Zhao. 2003. Recovery of ammonium-nitrogen from landfill leachate as a multi-nutrient fertilizer, Ecol. Eng. 20:171-181.
Li, X. Z., Q. L. Zhao, and X. D. Hao. 1999. Ammonium removal from landfill leachate by chemical precipitation, Waste Manag. 19:409-415.
Mahon, G. R., Gadekar, S., and P. Pullammanappallil. January 2011. Development of a Process for Recovery of Nutrients from Wastewater by Precipitation as Struvite, Florida Water Resources Journal. 17-22.
Marti, N., A. Bouzas, A. Seco, and J. Ferrer. 2007. Struvite precipitation assessment in anaerobic digestion processes, Chem. Eng. J. 141:67-74.
Murphy J, Riley J P (1962) A modified single solution method for the determination of phosphate in natural waters. Anal. Chim. Acta 27:31-36
Mylavarapu R, Wright D, Kidder G, Chambliss C G (2007) UF/IFAS standardized fertilization recommendations for agronomic crops. Coop. Ext. Serv. IFAS, Univ. of Florida. SL129. Available at: http://edis.ifas.ufl.edu/SS163.
Nelson, N. O., R. L. Mikkelsen, and D. L. Hesterberg. 2003. Struvite precipitation in anaerobic swine lagoon liquid: effect of pH and Mg:P ratio and determination of rate constant, Bioresour. Teclmol. 89:229-236.
O'Connor G A, Elliott H A (2006) The agronomic and environmental availability of biosolids-P (Phase II). Rep. 99-PUM-2T Water Environment Research Foundation, Alexandria, Va.
Ozturk, I., M. Altinbas, I. Koyuncu, O. Arikan, and C. Gomec-Yangin. 2003. Advanced physico-chemical treatment experiences on young municipal landfill leachates. Waste Manag. 23:441-446.
Mohan. G. R, Gadekar. S and Pullammanappallil. P. 2010. Development of a Process Model for Recovery of Nutrients from Wastewater by Precipitation as Struvite. Florida Water Resources Journal, Orlando, Fla., USA.
Mohan, G. R. 2012. An Integrated Technology for Recovery of Energy, Nutrients and Clean Water from Cellulosic Ethanol Stillage. Agricultural and Biological Engineering. Gainesville, University of Florida. Ph.D.: 29-61.
Ronteltap, M., M. Maurer, and W. Gujer. 2007. Struvite precipitation thermodynamics in source-separated urine, Water Res. 41:984-997.
Ronteltap, M., M. Maurer, R. Hausherr and W. Gujer. 2010. Struvite precipitation from urine—Influencing factors on particle size. Water Res. 44:2038-2046
S. Agyin-Birikorang, G. A. O'Connor, P. C. Pullammanappallil and G. R. Mohan. 2013. Recovery of Essential Plant Nutrients from Biofuel Residual. Gainesville, University of Florida: 1-24.
Sharpley A N, Moyer B (2000) Phosphorus forms in manure and compost and their release during simulated rainfall. J. Environ. Qual. 29:1462-1469.
Suzuki, K., Y. Tanaka, K. Kuroda, D. Hanajima, Y. Fukumoto, T. Yasuda, and M. Waki. 2007. Removal and recovery of phosphorous from swine wastewater by demonstration crystallization reactor and struvite accumulation device, Bioresour. Technol. 98:1573-1578.
Tian, Z. (2011). Anaerobic Digestion Of Biofuel Production Residues. Agricultural and Biological Engineering. Gainesville, University of Florida. Ph.D.
Yao, Y., B. Gao, et al. (2011). “Biochar derived from anaerobically digested sugar beet tailings: Characterization and phosphate removal potential.” Bioresource Technology 102(10): 6273-6278.
Zhang, L., L. Wan, et al. (2011). “Removal of phosphate from water by activated carbon fiber loaded with lanthanum oxide.” Journal of Hazardous Materials 190(1-3): 848-855.

We claim:

1. A system comprising a sequential batch reactor, wherein the reactor is filled wastewater and is seeded with a biomass.

2. The system according to claim 1, wherein the wastewater is cellulosic stillage generated from ethanol production or dairy manure.

3. The system according to claim 2, wherein the cellulosic stillage or dairy manure has been anaerobically digested.

4. The system according to claim 1, wherein biomass is cellulosic or lignocellulosic material.

5. The system according to claim 1, wherein the biomass is fibrous cellulosic or lignocellulosic material.

6. The system according to claim 1, wherein the pH within the reactor is at between 8.5-9.5 pH.

7. The system according to claim 1, further comprising an aeration device for sparging air into the reactor.

8. A method for the efficient removal of phosphorous and nitrogen nutrients from wastewaters via struvite precipitation comprising: providing a sequential batch reactor; introducing to the reactor wastewater; seeding the sequential batch reactor with biomass; adjusting the pH within the reactor; aerating the contents within the reactor; and allowing settling of sludge.

9. The method according to claim 8, wherein the wastewater is ethanol stillage or dairy manure.

10. The method according to claim 9, wherein the ethanol stillage is raw ethanol stillage or anaerobically digested ethanol stillage.

11. The method according to claim 9, wherein the dairy manure is anaerobically digested dairy manure.

12. The method according to claim 8, wherein the biomass comprises anaerobically treated stillage fibrous solids.

13. The method according to claim 12, wherein the anaerobically treated stillage fibrous solids were subjected to sieving prior to anaerobic digestion.

14. The method according to claim 13, wherein the wastewater comprises 1% (wet w/v) stillage solids.

15. The method according to claim 13, wherein the wastewater comprises 10% (wet w/v) stillage solids.

16. The method according to claim 8 further comprising the step of removing the sludge following cessation of aeration.

17. The method according to claim 8 further comprising the step of using the removed sludge for use as soil amendment.
